(19) United States
(12) Patent Application Publication
(10) Pub. No.: US 2020/0160450 A1
(43) Pub. Date: May 21, 2020

(54) SYSTEMS AND METHODS FOR DECISION TREE-BASED MANAGEMENT OF MARKET RISK STRESS SCENARIOS

(71) Applicant: JPMorgan Chase Bank, N.A., New York, NY (US)

(72) Inventors: Anuj Teotia, Bengaluru (IN); Sobhan S. Dasari, Fremont, CA (US); Andrew J. Scott, New York, NY (US); Stephen Koch, Teddington (GB); Sushant Khot, Jersey City, NJ (US); Hsin Yu Wang, Elmsford, NY (US)

(21) Appl. No.: 16/194,460

(22) Filed: Nov. 19, 2018

(51) Int. Cl. G06Q 40/06; G06N 5/04

(52) U.S. Cl. CPC G06Q 40/06; G06N 5/045

(57) ABSTRACT

A method for decision tree-based management of market risk stress scenarios may include: receiving, from a front office system, a shock request comprising a scenario and a risk factor; retrieving the scenario from a scenario definition store, the scenario definition store comprising a plurality of scenarios; normalizing the risk factor resulting in standardized risk exposure; retrieving, from the retrieved scenario, a decision tree matching a risk factor type for the standardized risk factor, the decision tree comprising a plurality of nodes, each node having a shock instruction comprising an explicit shock instruction or no shock instruction; traversing the decision tree to identify a node that matches the standardized risk factor; and returning the shock instruction to the front office system, the returned shock instruction comprising the explicit shock instruction associated with the matching node or the last explicit shock instruction traversed before traversing to the matching node.

### BACKGROUND OF THE INVENTION

### 1. Field of the Invention

The present disclosure generally relates to systems and methods for decision tree-based management of market risk stress scenarios.

### 2. Description of the Related Art

Stress testing frameworks are often used for active market risk management to compliment statistical risk management tools, like Value at Risk (VAR) by providing exposure information to potential risk events. Stress testing is done using a variety of market risk scenario definitions that reflect the plausible or observed historical market moves. While designing the scenario definitions for standard moves (e.g., +100%) is straight forward, management of subjective or supervisory scenario definitions that need to ensure complete coverage of shocks for all the risk factors with appropriate granularity to reflect idiosyncratic moves is a challenge. Indeed, many firms have standardized scenario framework using differing levels of shock severity to achieve comparability of stresses.

### SUMMARY OF THE INVENTION

Systems and methods for decision tree-based management of market risk stress scenarios are disclosed. According to one embodiment, in an information processing apparatus comprising at least one computer processor, a method for decision tree-based management of market risk stress scenarios may include: (1) receiving, from a front office system, a shock request comprising a scenario and a risk factor; (2) retrieving the scenario from a scenario definition store, the scenario definition store comprising a plurality of scenarios; (3) normalizing the risk factor resulting in standardized risk exposure; (4) retrieving, from the retrieved scenario, a decision tree matching a risk factor type for the standardized risk factor, the decision tree comprising a plurality of nodes, each node having a shock instruction comprising an explicit shock instruction or no shock instruction; (5) traversing the decision tree to identify a node that matches the standardized risk factor; and (6) returning the shock instruction to the front office system, the returned shock instruction comprising the explicit shock instruction associated with the matching node or the last explicit shock instruction traversed before traversing to the matching node.

In one embodiment, each scenario in the scenario definition store may include a plurality of decision trees, each decision tree associated with a risk factor type.

In one embodiment, the node shock instruction may also include a relationship to a second node. The second node may be in the decision tree, or it may be in a different decision tree.

In one embodiment, the method may further include traversing to the second node in response to the shock instruction for the matching node identifying the relationship to the second node.

In one embodiment, the node shock instruction may also include a relationship to a second scenario, a second risk factor, a rule, etc.

According to another embodiment, a system for decision tree-based management of market risk stress scenarios may include a front office system, a scenario definition store storing a plurality of scenarios, and a central scenario management system executed by at least one computer processor. The central scenario management system may include a scenario definition access layer, a scenario/shock resolution service, a market risk selection criteria evaluator, and a risk factor data model. The scenario/shock resolution service may receive a shock request comprising a scenario and a risk factor from the front office system. The scenario definition access layer may retrieve the scenario from the scenario definition store. The scenario/shock resolution service may normalize the risk factor using the risk factor data model resulting in standardized risk exposure. The scenario/shock resolution service may retrieve, from the retrieved scenario, a decision tree matching a risk factor type for the standardized risk factor, the decision tree comprising a plurality of nodes, each node having a shock instruction comprising an explicit shock instruction or no shock instruction. The market risk selector criteria evaluator may traverse the decision tree to identify a node that matches the standardized risk factor. The scenario/shock resolution service may return the shock instruction to the front office system, the returned shock instruction comprising the explicit shock instruction associated with the matching node or the last explicit shock instruction traversed before traversing to the matching node.

In one embodiment, each scenario in the scenario definition store may include a plurality of decision trees, each decision tree associated with a risk factor type.

In one embodiment, the node shock instruction may also include a relationship to a second node. The second node may be in the decision tree, or it may be in a different decision tree. The market risk selector criteria evaluator may traverse to the second node in response to the shock instruction for the matching node identifying the relationship to the second node.

In one embodiment, the node shock instruction may also include a relationship to a second scenario, a second risk factor, a rule, etc.

In one embodiment, the system may further include a front office adapter that receives the scenario name and the risk exposure/factor from the front office system and provides the scenario name and the risk exposure/factor to the scenario/shock resolution service. The front office adapter may translate a format of the risk factor from a first format used by the front office system to a second format used by the central scenario management system.

In one embodiment, the front office system may apply the explicit shock.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for decision tree-based management of market risk stress scenarios according to one embodiment;

FIG. 2 depicts an architecture for decision tree-based management of market risk stress scenarios according to one embodiment;

FIG. 3 depicts an exemplary decision tree according to one embodiment; and

FIG. 4 depicts an exemplary composite scenario according to one embodiment.

### DETAILED DESCRIPTION OF PREFERRED EMBODIMENTS

Embodiments disclosed herein relate to systems and methods for decision tree-based management of market risk stress scenarios.

Embodiments involve a robust scenario definition framework that may incorporate decision trees to facilitate simpler, concise and extensible definitions. Embodiments may provide some or all of the following: (1) avoidance of the creating of ambiguous shocks by enabling mutually exclusive shock selection rules (e.g., Corporate, Regional, Supranational, Sovereign, and Municipal are mutually exclusive Issuer Types); (2) support data reusability via inter and intra scenario relationships (e.g. “Shock2”=1.5×“Shock1,” where the right hand side is derived from the left hand side dynamically within a given scenario or across scenarios; (3) the introduction of granular shocks (e.g., introduce granular shocks for Issuer Type:Corporate” by adding child nodes “Advanced Economies” and “Emerging Economies” by IssuerCountryofRisk; (4) the avoidance of data duplication by assigning just one shock to a group of risk factor attribute values (e.g., all countries belonging to the group “Advanced Economies” (risk factor attribute: IssuerCountryOfRisk) can be assigned just one shock; (5) the identification of a unique shock by risk factor attributes (e.g., identify a unique credit spread shock within a given scenario by IssuerType “Corporate” and IssuerCountryOfRisk “Advanced Economies”; and (6) the definition of new a new bespoke asset class or macro scenarios composing them from existing scenarios.

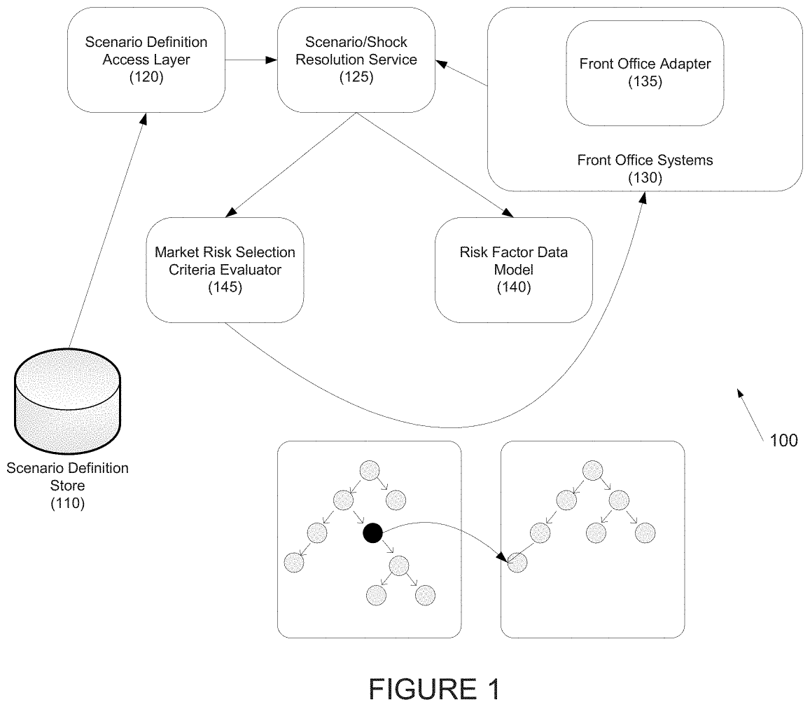

Referring to FIG. 1, an architectural diagram of a system for decision tree-based management of market risk stress scenarios is disclosed. System 100 may include scenario definition store 110, which may store one or more scenarios. Each scenario may include one or more decision trees. Each decision tree may be associated with a risk factor type.

Scenario definition access layer 120 may interface with scenario definition store 110 in order to retrieve one or more scenario. For example, scenario definition access layer 120 may access (e.g., read existing scenario definitions from the scenario definition store 110, update existing scenario definitions in scenario definition store 110, create new or delete existing scenarios in scenario definition store 110, etc.

Scenario/shock resolution service 125 may provide shock instructions for risk factor(s) in a shock scenario. In one embodiment, front office systems 130 may provide risk factor types and attributes to scenario/shock resolution service 125, and scenario/shock resolution service 125 may return shock instructions.

Scenario/shock resolution service 125 may communicate shock instructions to front office systems 130. In one embodiment, the shock instructions may be communicated to system adaptor 135. System adaptor 135 may pass a risk factor object containing a risk factor type (e.g., “Bond Spread”) and one-to-many attributes (e.g., IssuerType=Corporate and IssuerCountryOfRisk=Japan). Scenario/shock resolution service 125 may use market risk factor selection criteria evaluator 145 to “evaluate” the risk factor object from system adaptor 135 against scenario definitions from scenario definition access layer 120 and find the best-match shock instructions.

In one embodiment, because the central scenario management system (e.g., scenario definition store 110, scenario definition access layer 120, scenario/shock resolution service 125, system adaptor 135, risk factor data model 140, and market risk factor selection criteria evaluator 145) and front office systems 130 may use different jargons, front office systems 130 may use system adaptor 135 to translate the official language back to local dialog (e.g., translate a central risk factor type name to front office specific risk factor type name).

Market risk selection criteria evaluator 145 may evaluate if a risk factor object's attribute values (e.g., reference data) market data match the criteria specified in the scenario definition.

Risk factor data model 140 may define the attributes that are available for a given risk factor type. For example, a risk factor type “Bond Spread” can have attributes such as IssuerCountryOfRisk, Issuer Type. In embodiments, the risk factor data model may be used to standardize the jargons used by scenario mgmt. system and its consumers, such as front office systems 130.

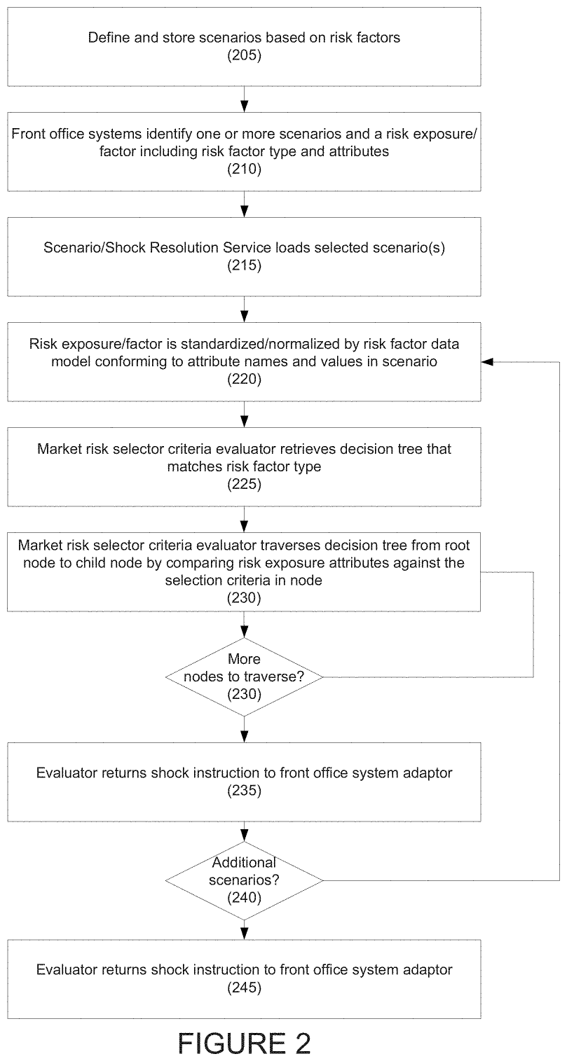

Referring to FIG. 2, a method for decision tree-based management of market risk stress scenarios is disclosed according to one embodiment.

In step 205, one or more scenarios may be defined and stored, for example, in a scenario definition store 110. In one embodiment, the scenarios may include one to many risk factor types. In a financial environment, example risk factor types may include interest rate, foreign exchange spot, credit single name, bond, etc. Each risk factor type may be associated with a decision tree, and each node in the decision tree may have a selection criterion and optional shock instruction.

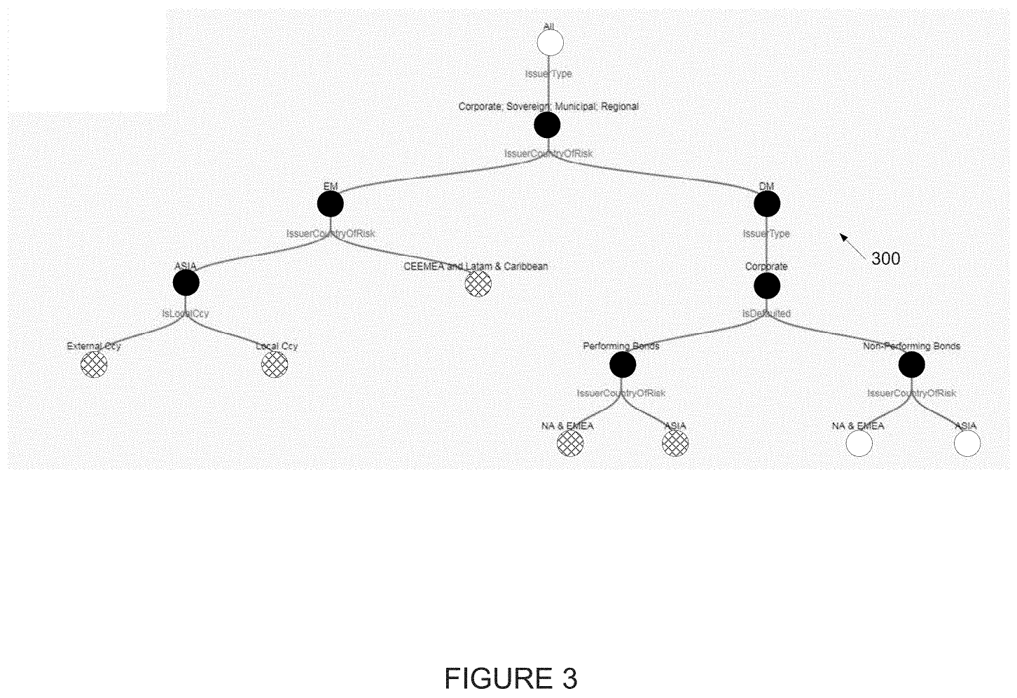

An example decision tree is provided in FIG. 3. FIG. 3 illustrates a shock decision tree for the risk factor type “CREDIT_SINGLE_NAME, BOND” (or Bonds markets) and the scenario “SevereSteeepenerRally.” Each node in decision tree 300 may have one of the three possible shock instruction states: no shock instruction (e.g., black solid nodes), an explicit shock instruction (e.g., white nodes), or a relationship (e.g., cross-hatched nodes) with another node, or in a node in a different table.

Referring again to FIG. 2, a trade may have one to many risk exposures, each of which may be a risk exposure/factor including a risk factor type (e.g., credit single name, bond, etc.) and a set of attributes (e.g., IssuerType=Corporate, IssuerCountryOfRisk=Japan, Currency=JPY).

In step 210, the front office systems may identify one or more scenarios and a risk exposure/factor including risk factor type and attributes. For example, the front office systems may identify a scenario, such as the Fed Adverse scenario. The front office systems may provide the scenario name and a risk exposure/factor to its system adapter, which may then provide this information to the scenario/shock resolution service.

In step 215, the scenario/shock resolution service may load selected scenario(s). In one embodiment, the selected scenarios may be loaded to a scenario definition access layer.

In one embodiment, any related scenarios (e.g., scenarios that may be referenced by the selected scenario(s) may be loaded. In another embodiment, the referenced scenarios may be loaded as needed.

In one embodiment, the scenario definition access layer may identify the relevant decision tree in the scenario.

In step 220, the risk exposure/factor may be standardized/normalized by using a risk factor data model that confirms attribute names and values to those in the scenario(s).

In step 225, the market risk selector criteria evaluator may receive the identified decision tree and the standardized risk exposure/factor.

In step 230, the market risk selector criteria evaluator may traverse decision tree from the root node to child node by comparing risk exposure attributes against the selection criteria in each node. It may further traverse one or more relationships with one or more additional decision trees.

In step 235, if there are mode nodes to traverse, the market risk selector criteria evaluator continues to traverse the decision tree.

If there are no additional nodes to traverse, the market risk selector criteria evaluator may return the last shock instruction traversed to the front office system adapter. For example, the last shock instruction be an explicit shock instruction or a relationship that may require the market risk selector criteria evaluator to traverse a different branch of the decision tree, or a different decision tree.

For example, referring to FIG. 3, the market risk selector criteria evaluator traverses or walks decision tree 300 as deep as possible to get to a child node, which it then examines for a shock instruction. If there is an explicit shock associated with the node (e.g., a black node), the market risk selector criteria evaluator will return the shock to the front office system adapter. If the shock instruction is a relationship (e.g., a cross-hatched node), the market risk selector criteria evaluator may traverse to a node in a different branch in the same decision tree, or to a node in a different decision tree in another scenario.

For example, the cross-hatched node with “External ccy” is an example where the market risk selector criteria evaluator will to traverse to the LargeSteepenerRally scenario and get to its CREDIT_SINGLE_NAME,BOND decision tree, and will traverse or walk that decision tree.

If there is no shock instruction associated with the node (e.g., a black node), the market risk selector criteria evaluator walks “backwards” to a parent node, and checks for a shock instruction until there is an explicit shock instruction or a relationship.

In step 240, the front office system adapter may the process for any remaining scenarios.

In step 245, the market risk selector criteria evaluator may return the shock instruction to the front office system adapter.

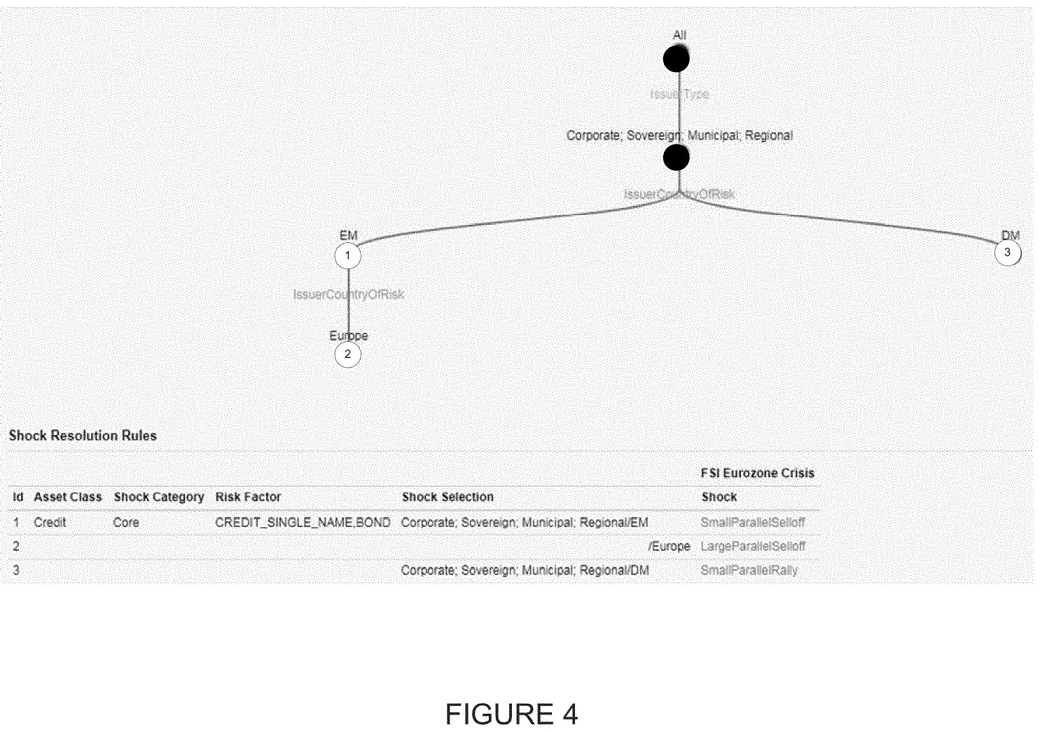

In one embodiment, a composite scenario may be retrieved by the scenario/shock resolution service. Referring to FIG. 4, an exemplary illustration a composite scenario is disclosed according to one embodiment. For example, the scenario name is “EuroZone Crisis.” For example, the nodes may identify either an explicit shock (e.g., black nodes) or a shock resolution rule (e.g., white node with a number in it). The tree depicted in FIG. 4 may be traversed in the same or similar manner as described above with regard to FIG. 3; however, instead of identifying a specific shock, a reference to or relationship with another scenario may be identified, and that scenario may be loaded (if not already done) and traversed.

For example, if the tree of FIG. 4 is traversed to end on node 1, the SmallParallelSelloff scenario, which is referenced in the rules, is traversed, using the risk factor CREDIT_SINGLE+_NAME, BOND. The tree for that risk factor type is then traversed until an explicit shock or another relationship is identified.

In one embodiment, machine learning may be used to predict an optimized decision tree based on the shock resolution traversal patterns. or example, if the shock decision tree has been designed in a way that it always requires N hops to identify a node that matches the standardized risk factor of a certain kind, the training model may suggest an optimized traversal algorithm resulting in a new decision tree.

In embodiments, the decision tree suggested may be used, or the static decision tree may be updated and/or refined as is necessary and/or desired.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for decision tree-based management of market risk stress scenarios comprising:
in an information processing apparatus comprising at least one computer processor:
receiving, from a front office system, a shock request comprising a scenario and a risk factor;
retrieving the scenario from a scenario definition store, the scenario definition store comprising a plurality of scenarios;
normalizing the risk factor resulting in standardized risk exposure;
retrieving, from the retrieved scenario, a decision tree matching a risk factor type for the standardized risk factor, the decision tree comprising a plurality of nodes, each node having a shock instruction comprising an explicit shock instruction or no shock instruction;
traversing the decision tree to identify a node that matches the standardized risk factor; and
returning the shock instruction to the front office system, the returned shock instruction comprising the explicit shock instruction associated with the matching node or the last explicit shock instruction traversed before traversing to the matching node.

2. The method of claim 1, wherein each scenario in the scenario definition store comprises a plurality of decision trees, each decision tree associated with a risk factor type.

3. The method of claim 1, wherein the node shock instruction further includes a relationship to a second node.

4. The method of claim 3, wherein the second node is in the decision tree.

5. The method of claim 3, wherein the second node is in a different decision tree.

6. The method of claim 3, further comprising:
traversing to the second node in response to the shock instruction for the matching node identifying the relationship to the second node.

7. The method of claim 1, wherein the node shock instruction further includes a relationship to a second scenario.

8. The method of claim 7, wherein the node shock instruction further includes a second risk factor.

9. The method of claim 1, wherein the node shock instruction further comprises a rule.

10. A system for decision tree-based management of market risk stress scenarios comprising:
a front office system;
a scenario definition store storing a plurality of scenarios;
a central scenario management system executed by at least one computer processor comprising:
a scenario definition access layer;
a scenario/shock resolution service;
a market risk selection criteria evaluator; and
a risk factor data model;
wherein:
the scenario/shock resolution service receives a shock request comprising a scenario and a risk factor from the front office system;
the scenario definition access layer retrieves the scenario from the scenario definition store;
the scenario/shock resolution service normalizes the risk factor using the risk factor data model resulting in standardized risk exposure;
the scenario/shock resolution service retrieves, from the retrieved scenario, a decision tree matching a risk factor type for the standardized risk factor, the decision tree comprising a plurality of nodes, each node having a shock instruction comprising an explicit shock instruction or no shock instruction;
the market risk selector criteria evaluator traverses the decision tree to identify a node that matches the standardized risk factor; and
the scenario/shock resolution service returns the shock instruction to the front office system, the returned shock instruction comprising the explicit shock instruction associated with the matching node or the last explicit shock instruction traversed before traversing to the matching node.

11. The system of claim 10, wherein each scenario in the scenario definition store comprises a plurality of decision trees, each decision tree associated with a risk factor type.

12. The system of claim 10, wherein the node shock instruction further includes a relationship to a second node.

13. The system of claim 12, wherein the second node is in the decision tree.

14. The system of claim 12, wherein the second node is in a different decision tree.

15. The system of claim 12, wherein the market risk selector criteria evaluator traverses to the second node in response to the shock instruction for the matching node identifying the relationship to the second node.

16. The system of claim 10, wherein the node shock instruction further includes a relationship to a second scenario.

17. The system of claim 16, wherein the node shock instruction further includes a second risk factor.

18. The system of claim 12, further comprising a front office adapter that receives the scenario name and the risk exposure/factor from the front office system and provides the scenario name and the risk exposure/factor to the scenario/shock resolution service.

19. The system of claim 18, wherein the front office adapter translates a format of the risk factor from a first format used by the front office system to a second format used by the central scenario management system.

20. The system of claim 10, wherein the front office system applies the explicit shock.
